(19) United States
(12) Patent Application Publication
(10) Pub. No.: US 2014/0049511 A1
(43) Pub. Date: Feb. 20, 2014

(54) TOUCH PANEL SYSTEM AND FABRICATION METHOD OF A TOUCH PANEL SYSTEM

(71) Applicant: YOMORE TECHNOLOGY CO., LTD., Kaohsiung City (TW)

(72) Inventors: Jao-Ching Lin, KAOHSIUNG CITY (TW); Wen-Ting Lee, KAOHSIUNG CITY (TW); Chun-Kai Ni, KAOHSIUNG CITY (TW)

(73) Assignee: YOMORE TECHNOLOGY CO., LTD., Kaohsiung City (TW)

(21) Appl. No.: 13/968,396

(22) Filed: Aug. 15, 2013

(30) Foreign Application Priority Data
Aug. 16, 2012 (TW) 101129695

(51) Int. Cl. G06F 3/041

(52) U.S. Cl. CPC G06F 3/041
USPC 345/174; 345/173; 29/622

(57) ABSTRACT

A touch panel system includes a touch panel and a processor. The touch panel includes at least one single-layer touch unit row. The processor is installed in a first axis of the at least one single-layer touch unit row for receiving and processing signals generating by the at least one single-layer touch unit row, and executing a corresponding operation accordingly. First wires coupled to a first single-layer touch unit row of the at least one single-layer touch unit row are extended to the processor along the first axis.

### BACKGROUND OF THE INVENTION

1. Field of the Invention

The present invention relates to a touch panel system and a fabrication method of a touch panel system, and particularly to a touch panel system and a fabrication method of a touch panel system that can make installation methods corresponding to all wires coupled to at least one single-layer touch unit row of a touch panel more flexible.

2. Description of the Prior Art

Please refer to FIG. 1. FIG. 1 is a diagram illustrating wires 102 coupled to a touch circuit 100 of a capacitive touch panel according to the prior art. As shown in FIG. 1, the wires 102 are first extended along two sides of the touch circuit 100 and then extended down to couple to a processor 104. Therefore, when number of touch units of the touch circuit 100 is increased, an installation method corresponding to the wires 102 in FIG. 1 will be limited due to width of the capacitive touch panel. For example, when number of the wires 102 is increased, areas of the two sides of the touch circuit 100 occupied the wires 102 is also increased. Thus, when the width of the capacitive touch panel is limited, the number of the wires 102 is also limited. Therefore, the installation method corresponding to the wires 102 in FIG. 1 is not good.

### SUMMARY OF THE INVENTION

An embodiment provides a touch panel system. The touch panel system includes a touch panel and a processor. The touch panel includes at least one single-layer touch unit row. The processor is installed in a first axis direction of the at least one single-layer touch unit row for receiving and processing signals generating by the at least one single-layer touch unit row, and executing a corresponding operation accordingly. First wires coupled to a first single-layer touch unit row of the at least one single-layer touch unit row are extended along the first axis.

Another embodiment provides a fabrication method of a touch panel system. The fabrication method includes forming at least one single-layer touch unit row on a touch panel; and forming first wires coupled between a first single-layer touch unit row of the at least one single-layer touch unit row and a processor along a first axis direction of the at least one single-layer touch unit row, where the first axis direction is toward the processor.

The present invention provides a touch panel system and a fabrication method of a touch panel system. The touch panel system and the fabrication method make first wires coupled to a first single-layer touch unit row of at least one single-layer touch unit row of a touch panel be extended along a first axis direction. Therefore, when number of touch units of the touch panel is increased, installation methods corresponding to all wires coupled to the at least one single-layer touch unit row of the touch panel can not be limited due to width variation of the touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating wires coupled to a touch circuit of a capacitive touch panel according to the prior art.

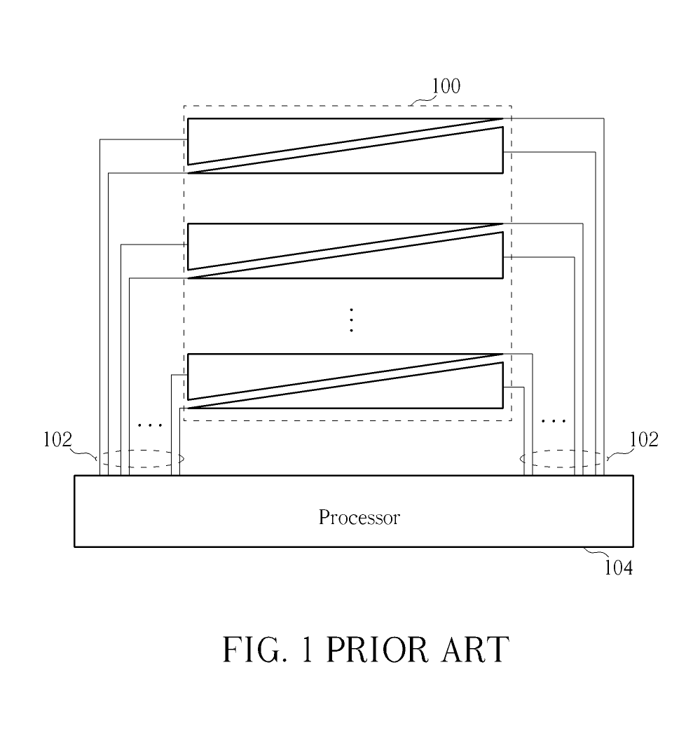

FIG. 2 is a diagram illustrating a touch panel system according to an embodiment.

FIG. 3 is a diagram illustrating single-layer touch units according to another embodiment.

FIG. 4 is a diagram illustrating a touch panel system according to another embodiment.

FIG. 5 is a diagram illustrating a touch panel system according to another embodiment.

FIG. 6 is a flowchart illustrating a fabrication method of a touch panel system according to another embodiment.

FIG. 7 is a flowchart illustrating a fabrication method of a touch panel system according to another embodiment.

FIG. 8 is a flowchart illustrating a fabrication method of a touch panel system according to another embodiment.

### DETAILED DESCRIPTION

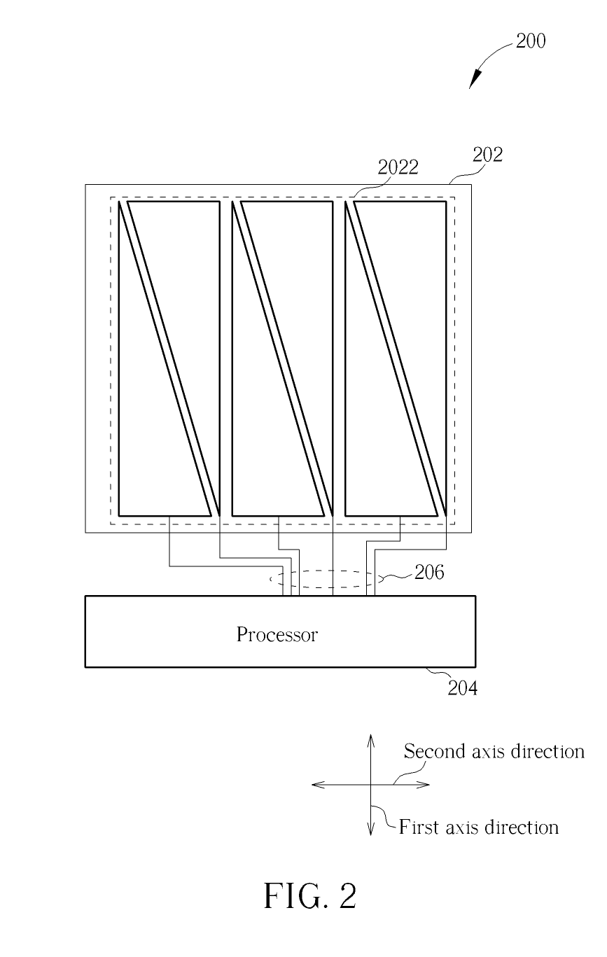

Please refer to FIG. 2. FIG. 2 is a diagram illustrating a touch panel system 200 according to an embodiment. The touch panel system 200 includes a touch panel 202 and a processor 204. The touch panel 202 includes a first single-layer touch unit row 2022, where the touch panel 202 can be a capacitive touch panel. But, the present invention is not limited to the touch panel 202 only including the first single-layer touch unit row 2022, that is, the touch panel 202 can include more than one single-layer touch unit row. The processor 204 is installed in a first axis direction of the first single-layer touch unit row 2022 for receiving and processing signals generating by the first single-layer touch unit row 2022, and executing a corresponding operation accordingly. First wires 206 coupled to the first single-layer touch unit row 2022 are extended along the first axis direction. As shown in FIG. 2, side length of each single-layer touch unit of the first single-layer touch unit row 2022 along the first axis direction is greater than side length of the single-layer touch unit of the first single-layer touch unit row 2022 along a second axis direction perpendicular to the first axis direction. In addition, the present invention is not limited to the first single-layer touch unit row 2022 including 6 single-layer touch units.

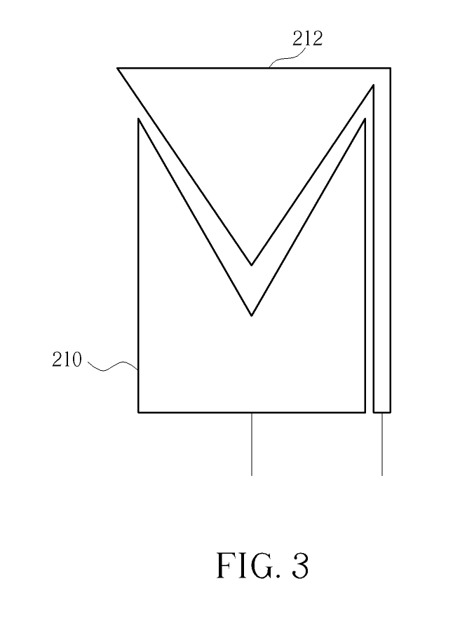

Please refer to FIG. 3. FIG. 3 is a diagram illustrating single-layer touch units 210, 212 according to another embodiment. As shown in FIG. 3, each two corresponding single-layer touch units (e.g. single-layer touch units 20222, 20224) of the first single-layer touch unit row 2022 can be replaced with the single-layer touch units 210, 212.

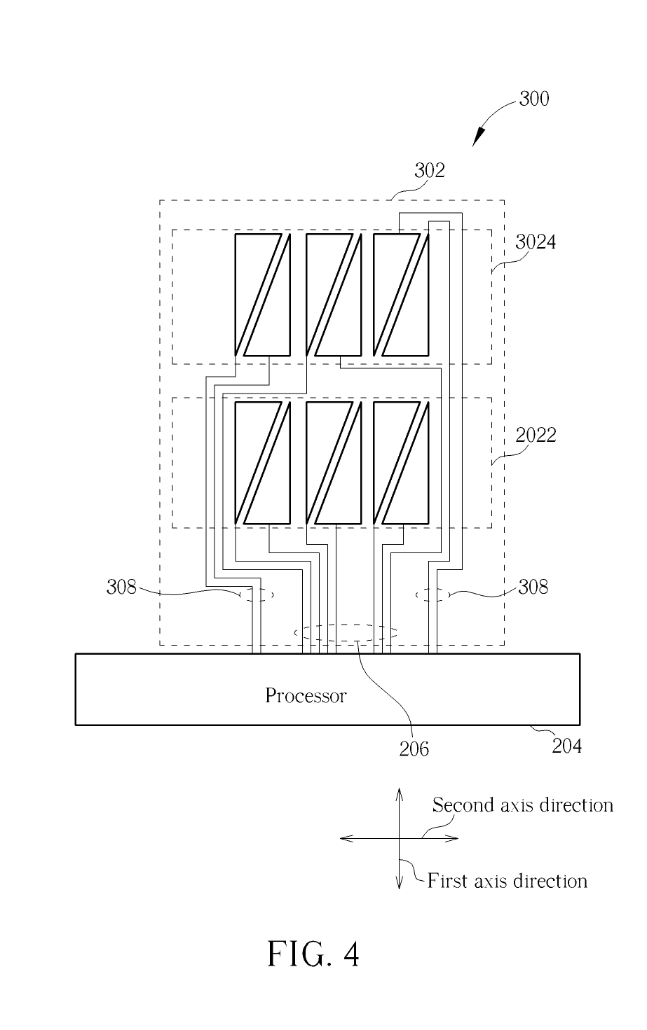

Please refer to FIG. 4. FIG. 4 is a diagram illustrating a touch panel system 300 according to another embodiment. A difference between the touch panel system 300 and the touch panel system 200 is that a touch panel 302 of the touch panel system 300 includes a first single-layer touch unit row 2022 and a second single-layer touch unit row 3024. But, the present invention is not limited to the touch panel 302 only including the first single-layer touch unit row 2022 and the second single-layer touch unit row 3024. As shown in FIG. 4, second wires 308 coupled to the second single-layer touch unit row 3024 are first extended along the first axis direction and then extended along the second axis direction to couple to the processor 204. As shown in FIG. 4, side length of each single-layer touch unit of the second single-layer touch unit row 3024 along the first axis direction is greater than side length of the single-layer touch unit of the second single-layer touch unit row 3024 along the second axis direction, where the second axis direction is perpendicular to the first axis direction. In addition, the present invention is not limited to the first single-layer touch unit row 2022 including 6 single-layer touch units and the second single-layer touch unit row 3024 including 6 single-layer touch units. In addition, any configuration in which the first wires 206 of the touch panel system 300 coupled to the first single-layer touch unit row 2022 are extended along the first axis direction falls within the scope of the present invention. Further, subsequent operational principles of the touch panel system 300 are the same as those of the touch panel system 200, so further description thereof is omitted for simplicity.

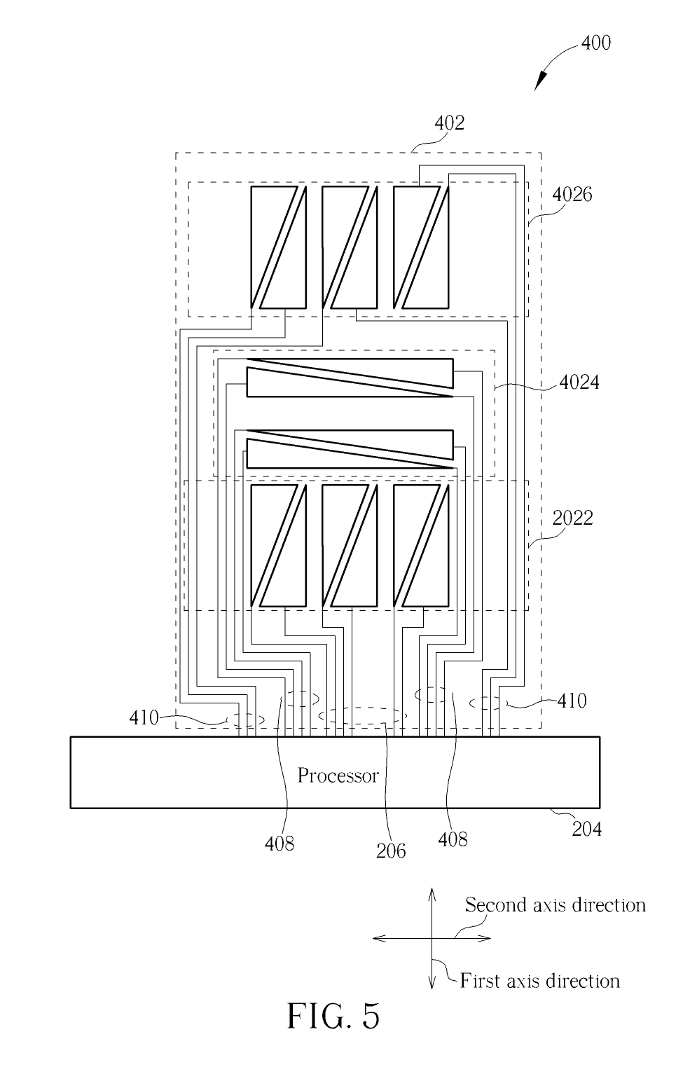

Please refer to FIG. 5. FIG. 5 is a diagram illustrating is a diagram illustrating a touch panel system 400 according to another embodiment. A difference between the touch panel system 400 and the touch panel system 200 is that a touch panel 402 of the touch panel system 400 includes a first single-layer touch unit row 2022, a second single-layer touch unit row 4024, and a third single-layer touch unit row 4026. But, the present invention is not limited to the touch panel 402 only including the first single-layer touch unit row 2022, the second single-layer touch unit row 4024, and the third single-layer touch unit row 4026. As shown in FIG. 5, second wires 408 coupled to the second single-layer touch unit row 4024 are first extended along the second axis direction and then extended along the first axis direction to couple to the processor 204; and third wires 410 coupled to the third single-layer touch unit row 4026 are first extended along the first axis direction and then extended along the second axis direction to couple to the processor 204. As shown in FIG. 5, side length of each single-layer touch unit of the second single-layer touch unit row 4024 along the second axis direction is greater than side length of the single-layer touch unit of the second single-layer touch unit row 4024 along the first axis direction, and side length of each single-layer touch unit of the third single-layer touch unit row 4026 along the first axis direction is greater than side length of the single-layer touch unit of the third single-layer touch unit row 4024 along the second axis direction, and the present invention is not limited to the first single-layer touch unit row 2022 including 6 single-layer touch units, the second single-layer touch unit row 4024 including 4 single-layer touch units, and the third single-layer touch unit row 4026 including 6 single-layer touch units. In addition, any configuration in which the first wires 206 of the touch panel system 400 coupled to the first single-layer touch unit row 2022 are extended along the first axis direction falls within the scope of the present invention. Further, subsequent operational principles of the touch panel system 400 are the same as those of the touch panel system 200, so further description thereof is omitted for simplicity.

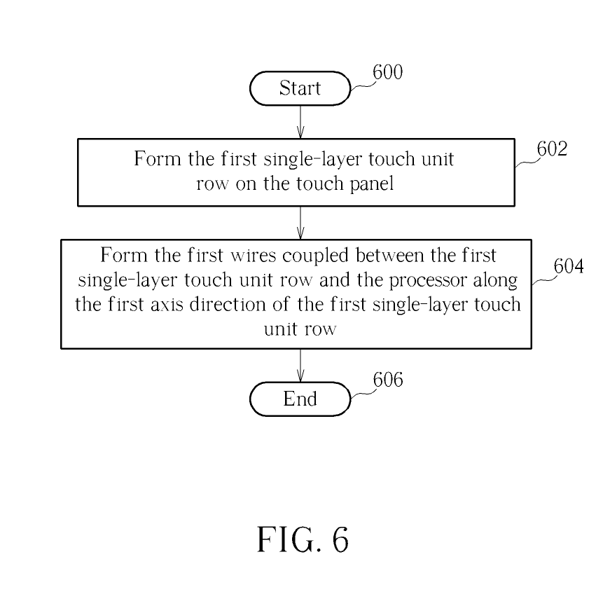

Please refer to FIG. 2 and FIG. 6. FIG. 6 is a flowchart illustrating a fabrication method of a touch panel system according to another embodiment. The fabrication method in FIG. 6 is illustrated using the touch panel system 200 in FIG. 2. Detailed steps are as follows:

Step 600: Start.

Step 602: Form the first single-layer touch unit row 2022 on the touch panel 202.

Step 604: Form the first wires 206 coupled between the first single-layer touch unit row 2022 and the processor 204 along the first axis direction of the first single-layer touch unit row 2022.

Step 606: End.

In Step 602, as shown in FIG. 2, side length of each single-layer touch unit of the first single-layer touch unit row 2022 along the first axis direction is greater than side length of the single-layer touch unit of the first single-layer touch unit row 2022 along the second axis direction perpendicular to the first axis direction.

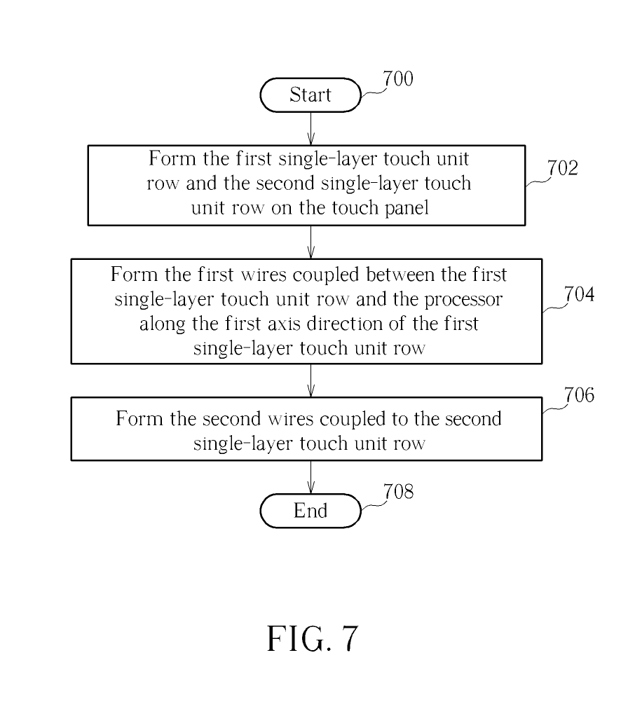

Please refer to FIG. 4 and FIG. 7. FIG. 7 is a flowchart illustrating a fabrication method of a touch panel system according to another embodiment. The fabrication method in FIG. 7 is illustrated using the touch panel system 300 in FIG. 4. Detailed steps are as follows:

Step 700: Start.

Step 702: Form the first single-layer touch unit row 2022 and the second single-layer touch unit row 3024 on the touch panel 202.

Step 704: Form the first wires 206 coupled between the first single-layer touch unit row 2022 and the processor 204 along the first axis direction of the first single-layer touch unit row 2022.

Step 706: Form the second wires 308 coupled to the second single-layer touch unit row 3024.

Step 708: End.

In Step 702, as shown in FIG. 4, side length of each single-layer touch unit of the first single-layer touch unit row 2022 along the first axis direction is greater than side length of the single-layer touch unit of the first single-layer touch unit row 2022 along the second axis direction perpendicular to the first axis direction, and side length of each single-layer touch unit of the second single-layer touch unit row 3024 along the first axis direction is greater than side length of the single-layer touch unit of the second single-layer touch unit row 3024 along the second axis direction. In Step 706, the second wires 308 are first extended along the first axis direction and then extended along the second axis direction to couple to the processor 204.

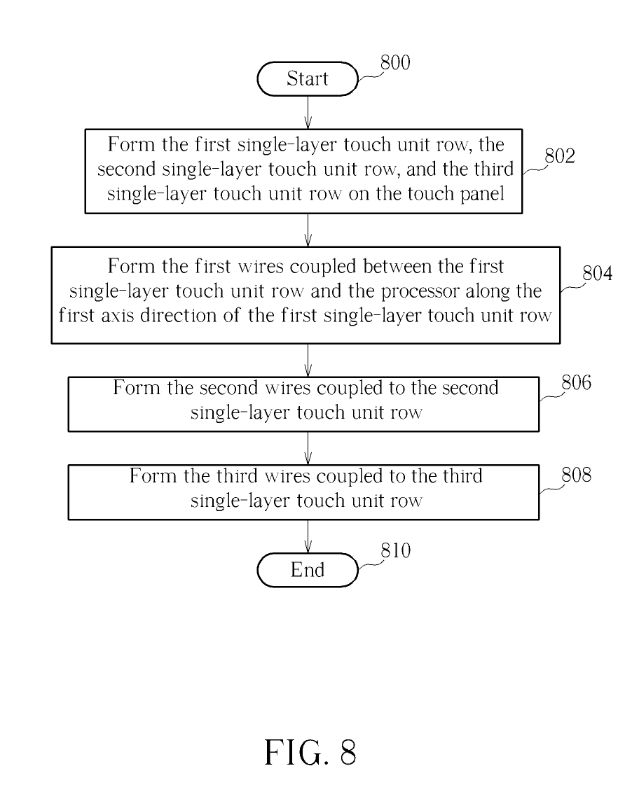

Please refer to FIG. 5 and FIG. 8. FIG. 8 is a flowchart illustrating a fabrication method of a touch panel system according to another embodiment. The fabrication method in FIG. 8 is illustrated using the touch panel system 400 in FIG. 5. Detailed steps are as follows:

Step 800: Start.

Step 802: Form the first single-layer touch unit row 2022, the second single-layer touch unit row 4024, and the third single-layer touch unit row 4026 on the touch panel 202.

Step 804: Form the first wires 206 coupled between the first single-layer touch unit row 2022 and the processor 204 along the first axis direction of the first single-layer touch unit row 2022.

Step 806: Form the second wires 408 coupled to the second single-layer touch unit row 4024.

Step 808: Form the third wires 410 coupled to the third single-layer touch unit row 4026.

Step 810: End.

In Step 802, as shown in FIG. 5, side length of each single-layer touch unit of the first single-layer touch unit row 2022 along the first axis direction is greater than side length of the single-layer touch unit of the first single-layer touch unit row 2022 along the second axis direction perpendicular to the first axis direction, side length of each single-layer touch unit of the second single-layer touch unit row 4024 along the second axis direction is greater than side length of the single-layer touch unit of the second single-layer touch unit row 4024 along the first axis direction, and side length of each single-layer touch unit of the third single-layer touch unit row 4026 along the first axis direction is greater than side length of the single-layer touch unit of the third single-layer touch unit row 4026 along the second axis direction. In Step 806, the second wires 408 are first extended along the second axis direction and then extended along the first axis direction to couple to the processor 204. In Step 808, the third wires 410 are first extended along the first axis direction and then extended along the second axis direction to couple to the processor 204.

To sum up, compared to the prior art, the touch panel system and the fabrication method of the touch panel system make the first wires coupled to the first single-layer touch unit row of the at least one single-layer touch unit row of the touch panel be extended along the first axis direction. Therefore, when number of touch units of the touch panel is increased, installation methods corresponding to all wires coupled to the at least one single-layer touch unit row of the touch panel can not be limited due to width variation of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel system, comprising:
a touch panel comprising at least one single-layer touch unit row; and
a processor installed in a first axis direction of the at least one single-layer touch unit row for receiving and processing signals generating by the at least one single-layer touch unit row, and executing a corresponding operation accordingly;
wherein first wires coupled to a first single-layer touch unit row of the at least one single-layer touch unit row are extended along the first axis.

2. The touch panel system of claim 1, wherein side length of each single-layer touch unit of the first single-layer touch unit row along the first axis direction is greater than side length of the single-layer touch unit of the first single-layer touch unit row along a second axis direction perpendicular to the first axis direction.

3. The touch panel system of claim 2, wherein second wires coupled to a second single-layer touch unit row of the at least one single-layer touch unit row are first extended along the first axis direction and then extended along the second axis direction.

4. The touch panel system of claim 3, wherein side length of each single-layer touch unit of the second single-layer touch unit row along the first axis direction is greater than side length of the single-layer touch unit of the second single-layer touch unit row along the second axis direction.

5. The touch panel system of claim 2, second wires coupled to a second single-layer touch unit row of the at least one single-layer touch unit row are first extended along the second axis direction and then extended along the first axis direction.

6. The touch panel system of claim 5, wherein side length of each single-layer touch unit of the second single-layer touch unit row along the second axis direction is greater than side length of the single-layer touch unit of the second single-layer touch unit row along the first axis direction.

7. The touch panel system of claim 5, wherein third wires coupled to a third single-layer touch unit row of the at least one single-layer touch unit row are first extended along the first axis direction and then extended along the second axis direction.

8. The touch panel system of claim 7, wherein side length of each single-layer touch unit of the third single-layer touch unit row along the first axis direction is greater than side length of the single-layer touch unit of the third single-layer touch unit row along the second axis direction.

9. The touch panel system of claim 1, wherein the touch panel is a capacitive touch panel.

10. A fabrication method of a touch panel system, the fabrication method comprising:
forming at least one single-layer touch unit row on a touch panel; and
forming first wires coupled between a first single-layer touch unit row of the at least one single-layer touch unit row and a processor along a first axis direction of the at least one single-layer touch unit row, wherein the first axis direction is toward the processor.

11. The fabrication method of claim 10, wherein side length of each single-layer touch unit of the first single-layer touch unit row along the first axis direction is greater than side length of the single-layer touch unit of the first single-layer touch unit row along a second axis direction perpendicular to the first axis direction.

12. The fabrication method of claim 11, further comprising:
forming second wires coupled to a second single-layer touch unit row of the at least one single-layer touch unit row, wherein the second wires are first extended along the first axis direction and then extended along the second axis direction.

13. The fabrication method of claim 12, wherein side length of each single-layer touch unit of the second single-layer touch unit row along the first axis direction is greater than side length of the single-layer touch unit of the second single-layer touch unit row along the second axis direction.

14. The fabrication method of claim 11, further comprising:
forming second wires coupled to a second single-layer touch unit row of the at least one single-layer touch unit row, wherein the second wires are first extended along the second axis direction and then extended along the first axis direction.

15. The fabrication method of claim 14, wherein side length of each single-layer touch unit of the second single-layer touch unit row along the second axis direction is greater than side length of the single-layer touch unit of the second single-layer touch unit row along the first axis direction.

16. The fabrication method of claim 14, further comprising:
forming third wires coupled to a third single-layer touch unit row of the at least one single-layer touch unit row, wherein the third wires are first extended along the first axis direction and then extended along the second axis direction.

17. The fabrication method of claim 16, wherein side length of each single-layer touch unit of the third single-layer touch unit row along the first axis direction is greater than side length of the single-layer touch unit of the third single-layer touch unit row along the second axis direction.
